(19) United States
(12) Patent Application Publication
(10) Pub. No.: US 2009/0193007 A1
(43) Pub. Date: Jul. 30, 2009

(54) Systems and methods for ranking search engine results

(76) Inventors: Andrea Filippo Mastalli, Monza (IT); Marco Ferra, Milano (IT); Massimiliano Giacomo Pinto, San Vittore Olona (IT); Andrea Spacca, Vigevano (IT)

Correspondence Address: GREER, BURNS & CRAIN, 300 S WACKER DR, 25TH FLOOR, CHICAGO, IL, 60606, US

(21) Appl. No.: 12/011,513

(22) Filed: Jan. 28, 2008

(51) Int. Cl. G06F 7/06

(52) U.S. Cl. 707/5; 707/E17.108

(57) ABSTRACT

Systems and methods for ranking search engine results based at least in part on user access to the results of previous search inquiries. Results to a search inquiry appearing on a search engine results page are ranked according to their relevance with respect to the search inquiry, and the ranking is based at least in part on an evaluation of user data associated with actions taken by one or more users in response to other search inquiries. The systems and methods retain data associated with search results for future use on a user specific or multi-user basis, and may access this data from local storage or centralized storage within a network.

### FIELD OF THE INVENTION

The present invention relates generally to ranking search engine results. More specifically, the present invention relates to a social search engine for ranking search engine results based on an evaluation of user actions such as user access to a document on the Internet.

### BACKGROUND OF THE INVENTION

A search engine is an information retrieval system that searches documents such as the text of web pages for keywords, and returns search results in the form of a listing of documents or links to websites where the keywords were found. Search engines work by matching a query, or request for information that includes keywords, against an index that typically has been created by the search engine. The index contains data that indicates the content of a large number of documents or websites and includes the keywords (or truncated versions of the keywords) as well as pointers to the locations of the keywords in each document. The index is searched for matches with the keywords, and these matches form the results of the search.

Search engines attempt to determine the relevance of each search result, and then to inform the searcher of the perceived degree of relevance of each search result. Various factors are used to determine this relevance, such as the frequency with which the keywords appear in the document, or the location in the document where the keywords appear (for example keywords in the title of a document might be deemed to be more important than keywords appearing near the end of the document). The intent of these ranking systems is to have the most relevant search results indicated at the top of the list of search results, where they are most likely to be visited by the searcher.

However, website owners, administrators, search engine marketers and promoters, can manipulate these results by repeating keywords in their web pages or meta tags. This skews search engine results so that an inferior website with misleading or redundant keywords could be considered more relevant to the query than it actually is. The perceived relevance of search engine results can be further manipulated by the payment of a fee by the owner of a particular website, advertising, or other techniques. This increases the likelihood that the searcher will visit a particular website that may not be the most relevant response to the query.

Furthermore, as the Internet continues to grow, so too does the number of associated documents and web pages that must be indexed or otherwise made subject to a search in response to a query. Presently, there are millions of web pages, and the number grows daily. This massive amount of ever-changing data is difficult to properly index and can overwhelm conventional search engines, resulting in a search engine returning a list of thousands of search results in response to a query. These long and unwieldy lists include many false-positives with content that does not adequately match that of the query, often resulting from ambiguous keywords or imperfect search algorithms. As a result it is difficult to adequately determine the importance of any one listing returned in response to a query over any other listing. This large number of results also increases the likelihood that the searcher will visit a particular website that may not be the most relevant response to the query.

It follows that lists of search engine results are influenced by several factors that can seriously diminish the objectivity of the search results and can direct a searcher to websites that may not be the most relevant ones responsive to the searchers query. Search engine results may be flooded with irrelevant responses, or the responses may be manipulated to seem more relevant than they really are. In either event it is plain to see the deficiencies of a listing of results that do not most closely correspond to the searcher request. Therefore, a problem arises when a searcher is required to visit irrelevant websites returned to the searcher in response to a query due both to the large number of search results returned and to artificial increases in the perceived relevancy of the search results.

### SUMMARY OF THE INVENTION

From the foregoing, it is apparent there is a direct need for creating a search engine results page, while reducing or eliminating excessive or irrelevant responses to a search inquiry. Further, it is desirable to prevent responses to search inquiries from manipulating a search engine so that the results appear more relevant to the search inquiry than they actually are. Thus, the aim of the present invention is to overcome the above mentioned problems by providing systems and methods for ranking search engine results that evaluate the contributions, inputs, or actions users have taken with respect to other search results.

Within this aim and in satisfaction of these needs, the present invention features systems and methods for ranking search engine results based on user activity taken in response to prior search engine results. To increase efficiency and reduce cost, these systems and methods may monitor, maintain, manipulate, or evaluate data associated with user activity in response to prior search results, and implement this data when ranking search engine results in response to a present inquiry. This provides a robust search engine results page where the search engine results are ranked according to their relevancy with respect to the inquiry, based on actual user data from one or more of a plurality of users, the user data being associated with actions taken in response to other search inquiries.

This aim and others are achieved by a method for ranking search engine results by monitoring activity of a user associated with a network to determine user access to primary links associated with a response to a first search inquiry. Primary data associated with user access to the primary links is stored in a local database associated with the user, and a copy of the primary data is stored in a centralized database that may be associated with a plurality of users. The method receives a second search inquiry, accesses at least one of the primary data or the copy of the primary data, and creates a search engine results page that is responsive to the second inquiry. The search engine results page includes a plurality of search engine results ranked based at least in part on an evaluation of at least one of the primary data or the copy of the primary data. The method may also display the search engine results page on a computer monitor.

The above mentioned aim and others are also achieved by a system for ranking search engine results, including a plurality of computers associated with a network and a processor associated with at least one of the computers that monitors activity of a user associated with the network to determine user access to at least one of a plurality of primary links associated with a response to a first search inquiry. A plurality of primary data associated with user access to one or more of the primary links is stored in a local database, and a copy of the primary data is stored in a centralized database. A receiver associated with one of the computers receives a second search inquiry, and the processor accesses at least one of the primary data or the copy of the primary data, and creates a search engine results page responsive to the second search inquiry. The search engine results page includes a plurality of search engine results ranked based at least in part on an evaluation of at least one of the primary data or the copy of the primary data. The system may also include a computer monitor displaying the search engine results page.

The above mentioned aim and others are also achieved by an article of manufacture comprising a program storage medium having computer readable program code embodied therein for ranking search results by at least one computer associated with a computer network where the computer readable program code in the article of manufacture causes a computer to monitor activity of a user associated with the computer network to determine user access to at least one of a plurality of primary links associated with a response to a first search inquiry. The computer readable code causes a computer to store a plurality of primary data associated with user access to at least one of the primary links in a local database, and to store a copy of the primary data in a centralized database. The computer readable code causes a computer to receive a second search inquiry, and to access at least one of the primary data or the copy of the primary data. The computer readable code causes a computer to create a search engine results page responsive to the second inquiry, where the search engine results page includes a plurality of search engine results ranked based at least in part on an evaluation of at least one of the primary data or the copy of the primary data. The computer readable code may cause a computer to display the search engine results page.

In certain embodiments, the systems and methods may also include monitoring activity of the user to determine user access to at least one of a plurality of secondary links, where the secondary link was accessed by the user via one of the primary links. Secondary data associated with user access to at least one secondary link may also be stored in a local database, and a copy of the secondary data may be stored in a centralized database. The systems and methods may access at least one of the secondary data or the copy of the secondary data, and may create a search engine results page where the search engine results are ranked based at least in part on an evaluation of at least one of the secondary data or the copy of the secondary data.

These aims and objects are achieved by the methods and systems according to independent claim 1 and any other independent claims. Further details may be found in the remaining dependent claims.

Other aspects and advantages of the present invention will become apparent from the following detailed description, taken in conjunction with the accompanying drawings, illustrating the principles of the invention by way of example only.

### BRIEF DESCRIPTION OF THE DRAWINGS

The foregoing and other objects, features, and advantages of the present invention, as well as the invention itself, will be more fully understood from the following description of various embodiments, when read together with the accompanying drawings, in which:

FIG. 1 is a flow chart depicting a method of ranking search engine results in accordance with an embodiment of the invention; and

FIG. 2 is a block diagram depicting a system for ranking search engine results in accordance with an embodiment of the invention.

FIG. 3 is a block diagram depicting in more detail a system for ranking search engine results in accordance with an embodiment of the invention.

### DETAILED DESCRIPTION

As shown in the drawings for the purposes of illustration, the invention may be embodied in systems and methods for ranking search engine results. These systems and methods generally evaluate data based on access by one or more users to web pages associated with previous search results to rank the search engine results of a subsequent search. Embodiments of the invention may store data locally or in a centralized database, and data associated with one user may be accessed from either a local or centralized database and evaluated to rank search engine results in response to a subsequent request from any of a plurality of users.

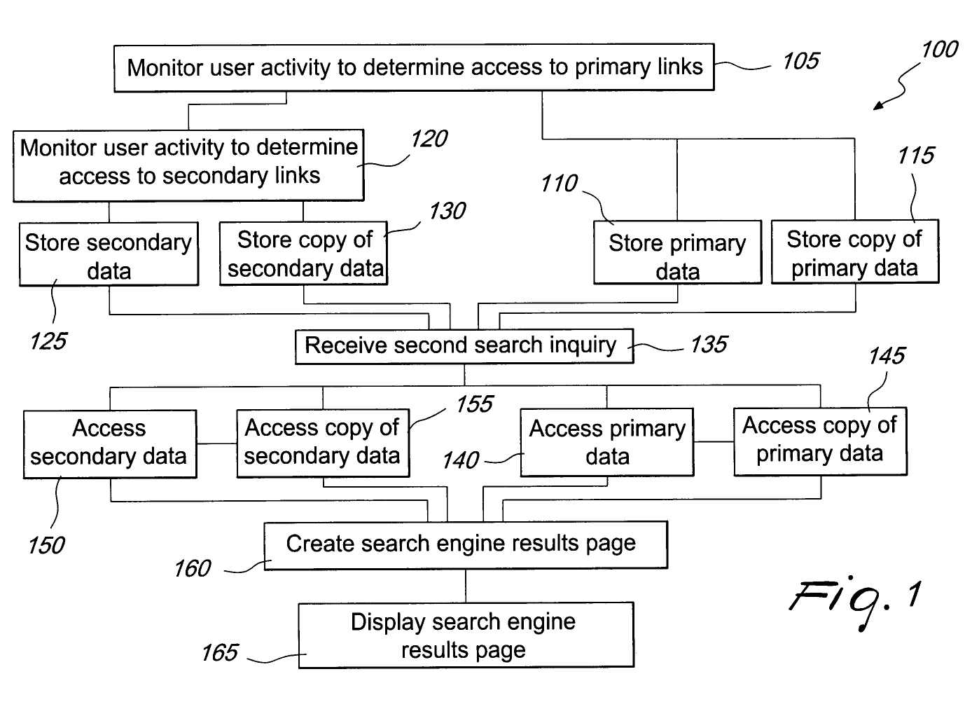

In brief overview, FIG. 1 is a flow chart depicting a method 100 of ranking search engine results in accordance with an embodiment of the invention. Method 100 generally includes the step of monitoring activity of a user associated with a network to determine user access to at least one of a plurality of links (STEP 105). Monitoring step (STEP 105) may include monitoring activity of a user associated with a network to determine user access by the user to at least one of a plurality of primary links associated with a response to a first search inquiry. Monitoring (STEP 105) may by accomplished by means of a processor associated with a network that is adapted to monitor the actions of one or more users to determine when one of the users accesses one or more links, such as a hyperlink, to access a web page. The monitoring step (STEP 105) generally determines when user activity on the network takes place. For example, this activity may include a user accessing a web page in response to a search inquiry by, for example, clicking on a link to that web page. Monitoring (STEP 105) user activity associated with the network may take place at a local client computer associated with a particular user, or monitoring (STEP 105) may be initiated or controlled by a processor operating from a remote centralized location within the network. In various embodiments, monitoring (STEP 105) may include determining when any user activity on or through the network takes place.

Method 100 proceeds with storing (STEP 110) in a local database associated with the user a plurality of primary data associated with user access to at least one of the primary links. Primary data may include, for example, the time a user spends visiting a web page accessed by the user clicking on one of the primary links. Storing step (STEP 110) generally includes saving or storing the primary data in any computer readable form, and may include various forms of RAM, ROM, or other memory. Storing (STEP 110) the primary data may occur in a database associated with a client computer, and storing step (STEP 110) generally occurs in a local database associated with the user who accessed the primary link or links. The primary data may be stored (STEP 110) on a local database that may or may not be generally accessible from the network. In various embodiments, the primary data stored in the local database may be identifiable as being associated with a user, and storing (STEP 110) the primary data in a local database may include storing a copy of the primary data in a local database.

Method 100 further may proceed by storing (STEP 115) in a centralized database a copy of the primary data. This storing step (STEP 115) generally includes storing a copy of the primary data in any computer readable medium. Typically, storing a copy of the primary data (STEP 115) includes storing the copy of the primary data in a centralized location within the network, so that it may be accessed by any computer associated with the network. Method 100 generally may identify a user associated with the copy of the primary data that is stored in a centralized database (STEP 115). This user is typically the user who accessed one or more primary link. In various embodiments method 100 may store in a centralized database either the primary data or a copy of the primary data.

Method 100 may include the step of monitoring activity of a user to determine user access to one or more secondary links (STEP 120). This monitoring step (STEP 120) functions similarly to monitoring user activity to determine access to the primary links (STEP 105), however this monitoring step (STEP 120) monitors user activity to determine user access to one or more secondary links. Generally, a secondary link is a hyperlink that does not directly appear as a response to a first search inquiry, but is accessed via a link appearing on a web page, where the web page was accessed by a user clicking on a primary link.

For example, a user receives a response to a first search inquiry. This response typically includes a listing of links to a series of web pages that a search engine has provided in response to the first search inquiry. These links—that appear on a search engine results page displayed in response to a first search inquiry—are defined herein as primary links. When accessed by a user (by clicking on the link) the primary links generally lead to a web page. That web page itself may include further links, defined herein as secondary links. When accessed by a user, secondary links generally open another web page. These secondary links may not appear on the search engine results page provided to the user in response to the first search inquiry, but may still be relevant to the first search inquiry. A user often accesses these secondary links in an attempt to find a satisfying response to the first search inquiry. Secondary links generally include any links on the search trail made available to or accessed by the user that do not appear directly on the search engine results page that is displayed in response to a first search inquiry. This may include web pages that are many pages removed from the web pages that are displayed when a user accesses a primary link. Monitoring step (STEP 120) monitors user activity to determine user access to one or more secondary links.

Typically, once a user accesses a secondary link, monitoring step (STEP 120) determines that this access has occurred and method 100 proceeds with the step of storing in a local database a plurality of secondary data associated with user access to at least one secondary link (STEP 125). Storing step (STEP 125) generally occurs in a local database associated with the user who accessed the secondary link or links. Storing secondary data in a local database (STEP 125) generally includes storing the data in any computer readable format, and may include the use of various types of RAM, ROM, or other forms of memory. In various embodiments, a copy of the secondary data may be stored in a local database.

Typically, in embodiments where user activity includes accessing secondary links, method 100 includes storing in a centralized database a copy of the secondary data (STEP 130). This storing step (STEP 130) generally includes storing a copy of the secondary data in any computer readable medium. Typically, storing a copy of the secondary data (STEP 130) includes storing the copy of the secondary data in a centralized location within the network, so that it may be accessed by any computer associated with the network. Method 100 generally may identify a user associated with the copy of the secondary data that is stored in a centralized database (STEP 130). This user is typically the user who accessed the secondary links. In various embodiments, method 100 may store in a centralized database the secondary data or a copy of the secondary data.

Method 100 generally includes receiving a second search inquiry (STEP 135). Receiving a second search inquiry (STEP 135) may include receiving one or more keywords entered, for example, into a computer or search engine interface by any user associated with or having access to the network. Generally, the second search inquiry may be received (STEP 135) either from a user who accessed at least one primary link in response to a first search inquiry or from a different user. The second search inquiry is generally independent from the first search inquiry, but in various embodiments may include one or more of the same keywords. In various embodiments, the second search engine may be received (STEP 135) by a receiver, processor, or search engine.

In response to receiving a second search inquiry (STEP 135), method 100 may include accessing the primary data (STEP 140). Method 100 may also access the copy of the primary data (STEP 145). Typically, method 100 accesses either the primary data from the local database (STEP 140) or the copy of the primary data from the centralized database (STEP 145). Both accessing the primary data (STEP 140) and accessing the copy of the primary data (STEP 145) generally include making the data available from its storage location for processing, evaluation, or manipulation. This may include a processor accessing either the primary data or a copy of the primary data.

Similarly, in embodiments of the invention where a user accesses secondary links, method 100 may proceed by accessing the secondary data (STEP 150). Method 100 may also access the copy of the secondary data (STEP 155). Typically, method 100 accesses either the secondary data from the local database (STEP 150) or the copy of the secondary data from the centralized database (STEP 155). Both accessing the secondary data (STEP 150) and accessing the copy of the secondary data (STEP 155) generally include making the data available from its storage location for processing, evaluation, or manipulation. This may include a processor or search engine accessing either the secondary data or a copy of the secondary data.

Once accessing one or more of the primary data, copy of the primary data, secondary data, or copy of the secondary data, method 100 generally proceeds by creating a search engine results page (STEP 160) responsive to the second search inquiry. The search engine results page (SERP) that is created (STEP 160) may include a plurality of search engine results, such as links to web pages, ranked based at least in part on an evaluation of at least one of the primary data or the copy of the primary data. In various embodiments, SERP that is created (STEP 160) may also include a plurality of search engine results ranked based at least in part on an evaluation of at least one of the secondary data or a copy of the secondary data. Similarly, creating the SERP (STEP 160) may include an evaluation of any or all of the primary data, copy of the primary data, secondary data, or copy of the secondary data or any other data related to user activity with respect to prior search results. In a typical embodiment, evaluating any of the primary or secondary data, or copies thereof, may include a processor adapted to perform logic operations on the data in order to rank web pages associated with any of the data to determine their degree of relevance with respect to the second search inquiry, based on primary or secondary data, (or copies thereof) that were collected in response to user activity or actions taken with respect to a response to a first search inquiry. The logic operations may be associated with a computer program in a computer readable medium that may be accessed by any computer connected to the network.

Method 100 may then proceed with displaying the search engine results page (STEP 165). The search engine results page (SERP) is generally responsive to the second search inquiry, and generally includes search engine results that are ranked at least in part based on an evaluation of the primary data, secondary data, or copies thereof. Displaying step (STEP 165) may include displaying the SERP on a computer monitor, or otherwise making the contents of the search engine results page available to a user, who in various embodiments may or may not be the user associated with the second search inquiry, the first search inquiry, or both.

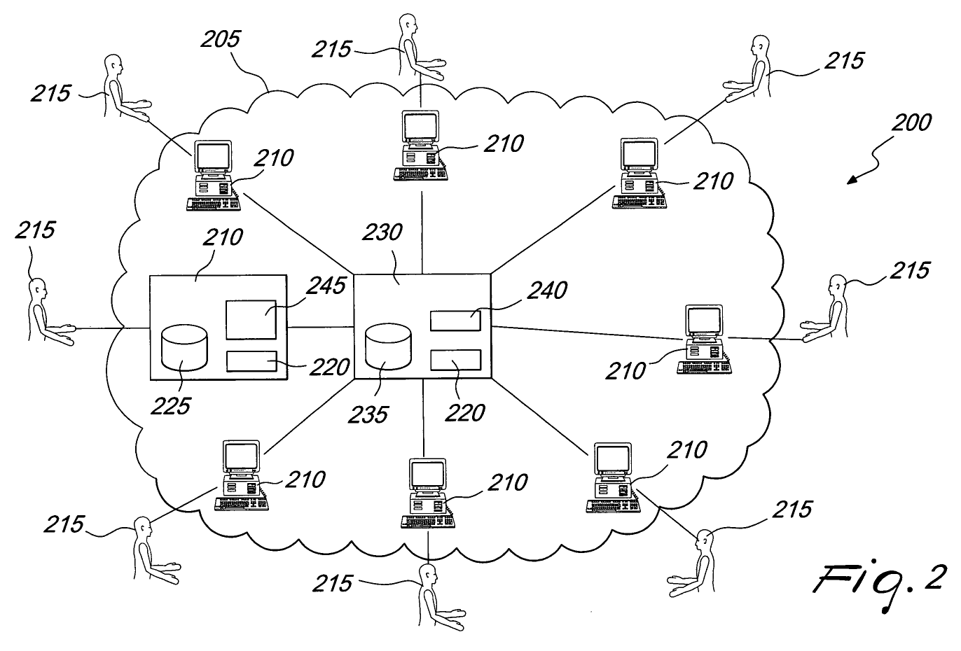

In brief overview, FIG. 2 is a block diagram depicting a system 200 for ranking search engine results in accordance with an embodiment of the invention. System 200 generally includes a network 205. Network 205 may be any network, such as an Internet, intranet, wide area network, local area network, or other computer oriented network. Network 205 typically includes a plurality of computers 210. Computers 210 may be any computer, such as a general purpose personal computer, or any computer with sufficient processing power and memory capability for performing the operations described herein. Computers 210 are generally capable of transmitting and receiving data to and from other computers 210 via network 205. Each computer 210 may be associated with one or more users 215. User 215 is typically a human operator using computer 210 and network 205. In various embodiments there may be any number of users 215 associated with any of computers 210. Collectively, users 215 generally form the community of people with access to network 205.

Each computer 210 may include a processor 220. Processor 220 may be integral to computer 210 or may be an external component that is associated with computer 210, for example via network 205. In various embodiments processor 220 may be associated with any search engine such as search engine 230. Generally, processor 220 is capable of interpreting computer program instructions and performing logic operations. Each processor 220 may access data, manipulate or evaluate that data, and output a result based at least in part on that data evaluation or manipulation.

Processor 220 is typically adapted to monitor activity of user 215 associated with network 205 to determine user 215 accesses at least one of a plurality of primary links associated with a response to a first search inquiry. Generally, the primary links are a listing of links to websites that are displayed in response to a first search inquiry. In other words the primary links are generally the results of the first search inquiry. The first search inquiry may be made by any of users 215. In various embodiments, the first search inquiry may be made by the same user 215 who accesses at least one primary link associated with a response to the first search inquiry. Alternatively, the first search inquiry may be made by a different (i.e., second) user 215 than the user 215 who accesses at least one primary link associated with a response to the first search inquiry. As used herein, all users may be referred to collectively as users 215, where users 215 represent a plurality of different individual people.

The first search inquiry is typically processed by at least one search engine 230. Search engine 230 may include hardware such as processor 220 adapted to perform logic operations to search network 205 for documents containing a keyword, subject, or phrase specified by one of users 215. In various embodiments any processor 220 may act as search engine 230, and thus processor 220 and search engine 230 may, in some embodiments, be referred to interchangeably.

In various embodiments, processor 220 monitors one or more of system 200 components associated with network 205 to determine if one or more user 215 accesses one or more primary links. This access may, for example, include any of users 215 clicking on a primary link to open a web page associated with that primary link. Once user 215 accesses a primary link, primary data associated with this user 215 access is typically stored in local database 225. Local database 225 is generally associated with one of computers 210 and includes memory storage means such as various types of RAM or ROM, for example. In an embodiment, if a user 215 accesses a primary link, the data evidencing that this access occurred is created. This data is generally referred to herein as primary data, and this primary data may be stored in local database 225. In various embodiments, local database 225 may be associated with the same computer 210 that user 215 used to access one of a plurality of primary links. Although not shown, every computer 210 may be associated with a local database 225 and processor 220. In various embodiments, local database may or may not be accessible from other computers 210 associated with network 205.

In various embodiments, a copy of the primary data may be stored in one or more centralized databases 235. Centralized database 235 is generally associated with search engine 230 as well as with network 205. In an embodiment centralized database 235 may be integral to search engine 230. Generally, centralized database 235 may be accessed by any of computers 210, and any of computers 210 may transmit data to and receive data from centralized database 235. Furthermore, centralized database 235 may also identify from which one of computers 210 or from which one of users 215 any data such as primary data originated. In other words, centralized database 235 may include profiles of a plurality of users 215 (or of computers 210).

For example a user—John Smith—may create a personal user profile with search engine 230. This profile may require a username, password, or both, as well as personal information such as age, gender, nationality, hobbies, and the like. When John Smith accesses a primary link associated with a response to a first search inquiry, primary data evidencing the fact that this access took place is created. This primary data may be stored in local database 225, and a copy of the primary data may be stored in centralized database 235. In this illustrative embodiment, if John Smith created a user profile with search engine 230, centralized database 235 may determine what copy of primary data stored on centralized database 235 originated with John Smith. In various embodiments, centralized database 235 may reserve a portion of memory for John Smith, and any copies of primary or other data stored in that portion of memory may be identified by search engine 230 as having been created by John Smith accessing, for example, a primary link. In various embodiments either local database 225 or centralized database 235 may store the primary data, a copy of the primary data, or both. Generally the primary data and the copy of the primary data are the same and they are typically processed and evaluated identically by search engine 230 and computer 210, or any associated components.

In an embodiment, system 200 may also receive a second search inquiry. Generally the second search inquiry may be made by any of users 215. In various embodiments, the second search inquiry may be made by the same user 215 who accesses at least one primary or secondary link associated with a response to the first search inquiry. Alternatively, the second search inquiry may be made by a different (i.e., second) user 215 who is not the user 215 who accesses at least one primary or secondary link associated with a response to the first search inquiry.

Typically, the second search inquiry is received by a receiver 240 associated with search engine 230. In various embodiments (not shown) receiver 240 may be a component of any of computers 210, processor 220, or otherwise associated with network 205. Receiver 240 is typically adapted to receive search inquiries from any user 215. The second search inquiry is typically entered by one of users 215 and may include keywords, phrases or any general request for information. In various embodiments the second search inquiry may or may not have some keywords or other phrases in common with those used in the first search inquiry.

Continuing with the embodiment illustrated by system 200, processor 220, which in various embodiments may be a component of or associated with any of computers 210 or search engine 230, generally is adapted to accesses at least one of the primary data, secondary data, or copies thereof. This typically occurs in response to receipt of the second search inquiry by receiver 240. In various embodiments, primary data, secondary data, or copies thereof may be accessed from either of local database 225 or centralized database 235. Any of this data, once accessed, is generally available for manipulation or evaluation by processor 220.

Processor 220 and/or search engine 230 are generally adapted to create a search engine results page (SERP) responsive to the second search inquiry. Generally the search engine results page includes a listing of search engine results, and a search engine result, for example, may include a link to a website that the search engine has determined is responsive to the second search inquiry. The search engine results are generally ranked based on their degree of relevance to the second search inquiry. For example, the search engine results that are determined to be most relevant to the second search inquiry may be more prominently displayed on the listing of search engine results and may, for example, appear at the top of the listing of search engine results.

Processor 220 is typically responsible for ranking the search engine results, for example, by processing an algorithm or computer program. Processor 220 generally ranks the plurality of search engine results based at least in part on an evaluation of at least one of the primary data or the copy of the primary data. In various embodiments, the primary data is the data stored in local database 225 and the copy of the primary data is stored in centralized database 235, however the storage locations may in some embodiments be reversed. It follows that the search engine results page that contains the ranked listing of search engine results in response to the second search inquiry is ranked at least in part based on feedback (i.e. the primary or secondary data or copies thereof) from access by any user 215 to any primary link associated with a response to a first search inquiry.

In other words, user 215 activity with respect to prior search results is a factor in determining the ranking of search results for subsequent search inquiries. The user 215 activity may be based on prior activity of the same user 215, or from a different user 215 than the one who made the second search inquiry. In various embodiments primary data (or copies thereof) from more than one user 215 may be accessed and evaluated by processor 220 to rank search engine results. In this example, feedback data from a plurality of users 215 based on their access to a plurality of primary links associated with a plurality of responses to a plurality of prior (first) search inquiries is evaluated when ranking search engine results for a subsequent (second) search inquiry.

Primary data is generally data detailing user 215 access to at least one of a plurality of primary links associated with a response to a first search inquiry. Primary data may include an amount of time user 215 accessed a primary link, the number of times a user 215 accessed a primary link, a number of web pages associated with a primary link that is accessed by user 215, a number of web pages accessed by user 215 via one of the primary links, or a user transaction such as entering credit card or other personal or financial information into a web page accessed by user 215 via one of the links. A user 215 not accessing a primary link may also constitute primary data. Generally primary data captures relevant information regarding which web pages user 215 visited, or did not visit, in response to a search inquiry such as how long user 215 visited a web page, or how many times the user visited a web page. This data typically is indicative of the relevancy of the web pages to the search inquiry.

For example if user 215 spends only a few seconds viewing a web page that user 215 accessed by clicking on a primary link that is associated with a response to a search inquiry, it is unlikely that the web page was responsive to the search inquiry, whereas if user 215 spends several minutes viewing the web page it is likely that the web page is relevant. This data—time spent in this example—is recorded and may be used to rank the same primary links higher or lower when creating a search engine results page in response to a subsequent search inquiry by the same or a different user 215. For example, user 215 spending 5 seconds on a web page may cause a lower ranking for the link associated with that web page during a subsequent search inquiry, as it may be presumed that user 215 immediately found that web page to be non-responsive to the search inquiry. Copies of the primary data, which may for example be stored in centralized database 235, are generally identical copies of the primary data.

Secondary data is generally similar to primary data, however secondary data is based on user 215 access to any secondary link, as opposed to primary links. While primary links are typically the links displayed with the response to a first search inquiry, secondary links are typically not displayed with this response. Secondary links are generally accessed via a web page associated with one of the primary links.

For example, if a first search inquiry has the keywords “ski resort”, a plurality of primary links responsive to this search inquiry may be displayed that includes links to web pages of ski resorts located all over the world. John Smith—a user 215—accesses one of the links—a primary link—that opens a web page regarding ski resorts in Switzerland. The amount of time John spends viewing that web page is primary data that may be stored (in original or by copy) on local database 225 or centralized database 235. Continuing with this illustrative embodiment, the web page John accessed may include a listing of links that did not appear as any of the primary links. These secondary links may, for example, list each individual ski resort in Switzerland. John may then click on the link to a ski resort in the town of Saint Moritz. This is an example of user 215 access to a web page by use of a secondary link. Data, such as the amount of time John spends on the web page associated with the secondary link, is generally secondary data and may be stored (in original or by copy) in either local database 225 or centralized database 235. Data related to any further web page access by John based on continued deep linking is typically also considered secondary data.

If a second search inquiry is received from John or any other user 215, this primary or secondary data, or both, may be used to rank results associated with a response to the second search inquiry. For example, if a subsequent search inquiry is received by John or another user 215 with the keywords “Swiss vacations”, the fact that John, for example, spent a significant amount of time on the web page associated with the secondary link to a resort in Saint Moritz may cause that link to be ranked higher in the search engine results page created in response to the search inquiry for “Swiss vacations”. As can be seen, the keywords from the different search inquiries do not have to match, although in various embodiments they may be partially or completely identical.

In various embodiments, data associated with access by any user 215 to any links associated with a response to a search inquiry may be classified as primary data or secondary data. Collectively primary data, secondary data, or copies thereof may be referred to herein as “data” or “general data”. Primary data, secondary data, or both may be used to rank results (such as a plurality of links) to a subsequent search inquiry made after the data has been stored.

In various embodiments, the only user related activity data processor 220 and/or search engine 230 may access or evaluate when ranking search engine results is stored in local database 225. In other embodiments, only user activity related data processor 220 and/or search engine 230 may access or evaluate when ranking search engine results is stored in centralized database 235. It follows that in various embodiments the only user activity data analyzed or evaluated to rank search engine results may be one or more of the primary data, secondary data, or copies thereof. Additionally, search engine 230 and/or processor 220 may access centralized database 235 for data from only a uniquely identified user 215. In other words, if John Smith enters a subsequent search inquiry search engine 230 and/or processor 220 may rank the search engine results based in part on data from all users, data from a selected subgroup of users, or data associated only with John Smith. A selected sub group of users may include, for example, users 215 located in the same geographic location or users 215 with similar profiles, such as age, gender, language, hobbies, or the like.

For example, user John Smith may frequently enter search inquiries into computer 210. All data based on John's access to results from the searches may be stored in either local database 225 or centralized database 235 and may be identified as having been accessed by John Smith. After the existence of some data associated with John Smith is stored in either local database 225 or centralized database 235, when John enters a search inquiry into any computer 210, search engine 230 or processor 220 may, in some embodiments, access and evaluate only data from prior user 215 activity that is associated with John's access to previous search results when ranking results to John's present search inquiry. In other embodiments any data regarding activity from a plurality of users 215 may be accessed only from either centralized database 235 or one or more local databases 225. The search engine results may be ranked based in part on an evaluation of any data from a particular user 215, or from a plurality of users 215, and any of this data may be accessed either from local databases 225 or centralized database 235.

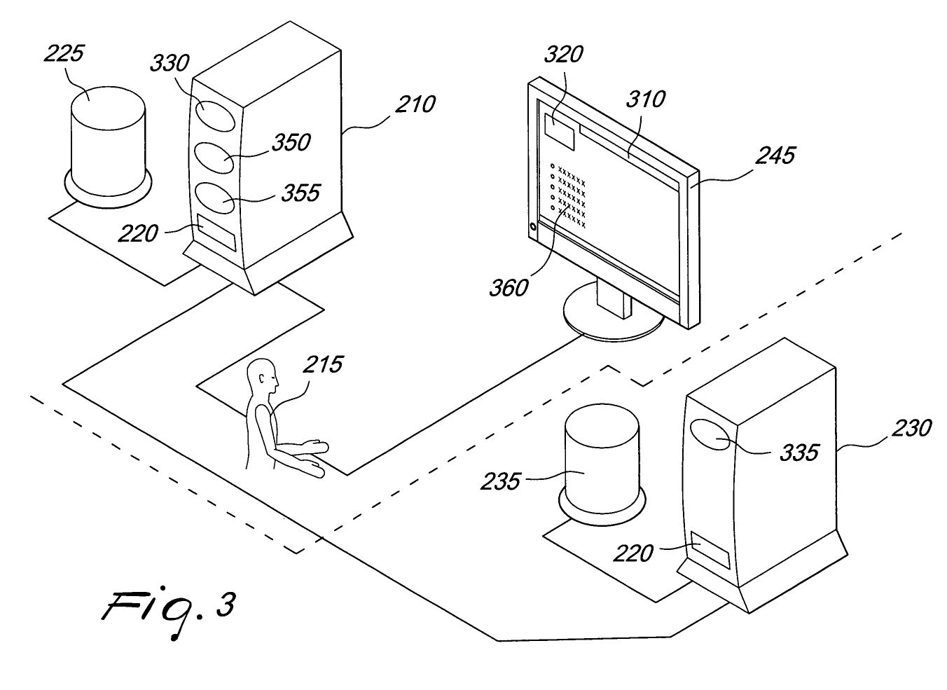

An embodiment of the system according to the disclosure will now be described in more detail with reference to FIG. 3. FIG. 3 shows a computer 210 including a monitor 245, a local database 225, a processor 220 and a browser application 310 for surfing the network. Browser 310 may a dedicated browser or a conventional browser for surfing the Internet, for instance Mozilla Firefox or Microsoft Internet Explorer, provided with a plug-in 320, which is as a module or agent monitoring the user's activity. Monitoring agent 320 is a software application that hooks actions performed by the user within browser 310 according to techniques known to the skilled in the art. Such actions may include page printing, page bookmarking, page saving, time spent on a page and so on, and may be classified in three categories: behavior, resources, context. Monitoring agent 320 may be already embedded in browser 310 if browser 310 is a dedicated software application

The following is an exemplary list of actions that may be monitored by monitoring agent 320:

TABLE 1

| Data | Data type |
|---|---|
| Time spent on a page | behavior |
| Page bookmarking | behavior |
| Page printing | behavior |
| Page saving | behavior |
| Image saving | behavior |
| Copying part of the document | behavior |
| Nunber of visits to page | behavior |
| Number of visits concerning a keyword or query string | behavior |
| Keyword density in document body | context |
| Keyword density in document title | context |
| Keyword density in document links | context |
| Query string density in document body | context |
| Query string density in document title | context |
| Query string density in document links | context |
| Visit depth in search session | behavior |
| Visit depth in navigation session | behavior |
| Marke by user to resources with respect to search | behavior |
| Marks by user to resources indipendently from context (star) | behavior |
| Click on page, in a single visit | Behavior |
| Submit made on page, in a single visit | Behavior |
| Use of “find” function during the visit | Behavior |
| Use of “stop” function during loading of resources | Behavior |
| Use of “reload” function to reload resources | Behavior |
| Resource server status during a particular visit | Resources |
| Weight of page in byte | Resources |
| Length in characters or words of document body | Resources |
| Use of “back” function | Behavior |
| Mouse position in a click | Behavior |
| Time spent in a domain | Behavior |
| Total time spent on resources | behavior |
| Keyword density in the host of the resource url | context |
| Query string composition (specialization, generalization) | behavior |
| Mouse scrolling activity | behavior |
| Document title | Resources |

This data may be simply recorded as such or grouped before saving to build models describing users' activity and their navigation within web resources, in order to to both foresee users' intentions and assign a mark to each <searched keyword—url> pair.

According to the disclosure, web resources may be ranked according to different strategies, one of which may be based on single user's feedback and another one based on aggregation of feedback from other users. To this purpose, Local Ranker 330 and Remote Ranker 335 are used.

Remote Ranker 335 is a software application that elaborates data collected at centralized database 235 and includes contributions from several users, while Local Ranker 330 is a software application that elaborates data locally available on the user's machine. Additionally, Semantic Analyzer 350 and Language Database 355 may cooperate to prompt input keywords to user 215, as will better become apparent in the following.

Local Ranker 330 operates in three steps: it collects and aggregates data, it computes a rank according to weighed parameters and it may adapt in time the weight of each parameter according to a self learning process.

Particularly, in the first step of data collecting and aggregation, parameter values are chosen according to sessions related to the keyword. A keyword may relate to a session if the query string for that session contains that keyword. For example, the term “dish” may relate to sessions generated by query strings such as “dish”, “install satellite dish”, “main course dish”.

Several data can be taken into account, including number of visits to a URL (xᵥᵢₛᵢₜₛ) time spent on the URL (x_{permTime}), explicit marks expressed by the user during search activity (x_{userVote}), marks expressed by the user through the commonly adopted star function (x_{urlStarTag}), marks expressed by the user through the star function with respect to the domain which the URL belongs to (x_{domainStartTag}), amount of actions performed on the URL (x_{activities}), e.g. printing, clicking, saving, and so on, keyword density in the URL contents (x_{contentKeywordDensity}), keyword density in the URL title (x_{titleKeywordDensity}) keyword density in the host (x_{hostKeywordDensity}), keyword density in the second level domain (x_{domainKeywordDensity}).

The second step concerns ranking results. Provided that p is the page identified by a URL, q is the searched query string, A is the set of data (visits, permTime, userVote, . . . ) taken into account, x is the components vectors, w is the weights vector, e.g. xⱼε(xᵥᵢₛᵢₜₛ, x_{userVote}, x_{permTime}, x_{urlStarTag}, . . . ) and Wⱼε(wᵥᵢₛᵢₜₛ, w_{userVote}, w_{permTime}, w_{urlStarTag}, . . . ).

In one embodiment, URL ranking is performed by the following linear combination:

r(p,q)=1/(1+e(Σwⱼ*xⱼ))

r(p,q)=1/(1+e^{(-((w}^{ᵥᵢₛᵢₜₛ}*^{x}^{ᵥᵢₛᵢₜₛ}^{)+(w}^{_{userVote}}*^{x}^{_{userVote}}^{)+( . . . )+(w}^{_{permTime}}*^{x}^{_{permTime}}⁾⁾⁺⁵⁾)

where rε[0,1]

In one embodiment, weight values may be defined as in Table 2:

TABLE 2

| Weight (w) | Value |
|---|---|
| Visits | 0.15 |
| PermTime | 0.02 |
| UserVote | 0.16 |
| UrlStarTag | 0.11 |
| DomainStarTag | 0.11 |
| Activities | 0.08 |
| keyDensity | 0.08 |
| titleKeyDensity | 0.1 |
| hostKeywordDensity | 0.1 |
| domainKeywordDensity | 0.1 |

The choice of weights is based on empiric consideration. For instance, the most significant values may concern the amount of visits and marks expressed by users 215. Keyword density in the title and in the document body may be considered to be relevant, while time spent on a page could be less valuable if considered alone, but may become more valuable when combined with other values, such as page weight to user's activities.

The third step concerns adapting parameter weights through time. Initially, the ranking mechanism according to the disclosure may assign a greater weight to user's marks, since this is an explicit feedback about the quality of the search results. Additionally, a time threshold may be introduced for time spent on a page, below which the time spent could be used to compute a negative index of the search results. In other embodiments, other feedback mechanisms can be introduced to adapt the value of each weight based on generated errors. For example, error sensibility can be improved supposing that all URLs marked favorably by user 215 positively affect search results while all URL marked negatively by user 215 negatively affect search results, even though, in the latter case, it may happen that user 215 is simply ignoring results rather than marking them negatively.

Semantic Analyzer 350 together with language database 355 can prompt the user with keywords associated to the keyword previously entered by the user on the ground that other users have already performed searches using the same keyword.

For example, with reference to FIG. 3, first user 215a has performed a search using a keyword; one of the results found by the search engine 230 is marked by generic user 215a as the most significant result. Local Ranker 330a elaborates the actions of user 215a and sends a report on the search to Remote Ranker 335.

When user 215b launches a search using the same keyword as used by user 215a, Local Ranker 330b communicates with Remote Ranker 335 and highlights results that are considered to be most important in view of the feedback left from first user 215a. This interaction between Local Ranker 330 and Remote Ranker 335 reduces search time by discarding results that are not relevant to the search.

More in detail, Remote Ranker 335 may combine and filter out data in order to identify meaningful <keyword—URL> pairs. External factors 340, including for instance Semantic Analyzer 350, may add to collected data to improve the system and prompt the user with suggested terms for the search. In this case, suggested terms provided to users are generated by aggregating and elaborating feedbacks of various members of the community.

A Data Analyzer (not shown) may be used to analyze data from single users and to compute and adapt parameter values with respect to single users, so as to build a complex model of a user's surfing activity that takes into account more factors. For example, significant factors that may be analyzed to improve the ranking system according to the disclosure include query preceding and following the current search, activity and time spent on the entire domain of a URL, ratio between the total time of the session and the time duration of a single visit, complexity of the page with respect the time spent on the page, choice of the URL with respect to other URLs listed in the proposed results 360, semantic relevance of the resource with respect to the query string entered by the user. The user may receive the outcome of such personal analysis during synchronization between Local Ranker 330 and Remote Ranker 335.

Note that in FIGS. 1 through 3, the enumerated items are shown as individual elements. In actual implementations of the described systems and methods, however, they may be inseparable components of other electronic devices such as a digital computer. Thus, actions described above may be implemented in software that may be embodied in an article of manufacture that includes a program storage medium. The program storage medium includes data signals embodied in one or more of a carrier wave, a computer disk (magnetic, or optical (e.g., CD or DVD, or both), non-volatile memory, tape, a system memory, and a computer hard drive.

From the foregoing, it will be appreciated that these systems and methods afford a simple and effective way to receive search results including links to web pages based only on the merit of the web pages themselves, or based on such factors as the level of past success users have had with the web pages that form the list of search results. The systems and methods according to various embodiments are able to retain data associated with search results for future use on a user specific or multi-user basis, and access this data based on localized database storage, central database storage, or both. This evaluation of prior user activity increases the efficiency, effectiveness, and accuracy of search results.

Any references to elements of the systems and methods herein used in the singular may also embrace embodiments including a plurality of these elements, and any references in plural to any element herein may also embrace embodiments including only a single element. References in the singular or plural form are not intended to limit the present invention, its components or elements.

Where technical features mentioned in any claim are followed by references signs, the reference signs have been included for the sole purpose of increasing the intelligibility of the claims and accordingly, neither the reference signs nor their absence have any limiting effect on the scope of any claim or of any claim elements.

One skilled in the art will realize the systems and methods described herein may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than the foregoing description, and all changes that come within the meaning and range of equivalency of the claims are therefore intended to be embraced therein.

1. A method of ranking search engine results, comprising:
monitoring, by a processor associated with a network, activity of a user associated with the network to determine user access by the user to at least one of a plurality of primary links associated with a response to a first search inquiry;
storing in a local database associated with the user a plurality of primary data associated with user access to at least one of the primary links;
storing in a centralized database a copy of the primary data;
receiving a second search inquiry;
accessing at least one of the primary data or the copy of the primary data;
creating a search engine results page responsive to the second search inquiry, the search engine results page including a plurality of search engine results ranked based at least in part on an evaluation of at least one of the primary data or the copy of the primary data; and
displaying the search engine results page on a computer monitor associated with the processor.

2. The method of claim 1, wherein the primary data includes at least one of an amount of time the user accessed one of the primary links, a number of times the user accessed one of the primary links, a number of web pages associated with one of the primary links that is accessed by the user, or a number of web pages accessed by the user via one of the primary links.

3. The method of claim 1, comprising:
identifying the copy of the primary data as being associated with the user.

4. The method of claim 1, comprising:
ranking the search engine results based at least in part on an evaluation of the primary data.

5. The method of claim 1, comprising:
ranking the search engine results based at least in part on an evaluation of the copy of the primary data.

6. The method of claim 1, comprising:
storing, in the centralized database, a copy of general data associated with access by a plurality of users to at least one of the primary links; and
ranking the search engine results based at least in part on the copy of general data associated with access by the plurality of users.

7. The method of claim 1, comprising:
receiving the second search inquiry from the user.

8. The method of claim 1, comprising:
receiving the second search inquiry from a second user.

9. The method of claim 1, wherein the first search inquiry comprises at least one first keyword and wherein the second search inquiry comprises at least one second keyword that is different from the first keyword.

10. The method of claim 1, comprising:
monitoring activity of the user to determine user access to at least one of a plurality of secondary links, each secondary link accessed by the user via at least one of the primary links;
storing in a local database a plurality of secondary data associated with user access to at least one of the secondary links;
storing in a centralized database a copy of the secondary data;
accessing at least one of the secondary data or the copy of the secondary data; and
creating the search engine results page with the plurality of search engine results ranked based at least in part on an evaluation of at least one of the secondary data or the copy of the secondary data.

11. The method of claim 10, comprising:
identifying the copy of the secondary data as being associated with the user.

12. The method of claim 10, comprising:
ranking the search engine results based at least in part on an evaluation of the secondary data.

13. The method of claim 10, comprising:
ranking the search engine results based at least in part on an evaluation of the copy of the secondary data.

14. The method of claim 10, wherein displaying the search engine results page comprises:
displaying at least one primary link or at least one secondary link.

15. The method of claim 10, wherein the secondary data includes at least one of an amount of time the user accessed one of the secondary links, a number of times the user accessed one of the secondary links, a number of web pages associated with one of the secondary links that is accessed by the user, or a number of web pages accessed by the user via one of the secondary links.

16. A system for ranking search engine results, comprising:
a plurality of computers associated with a network;
a processor associated with at least one of the computers adapted to monitor activity of a user associated with the network to determine user access to at least one of a plurality of primary links associated with a response to a first search inquiry;
a local database associated with the user storing a plurality of primary data associated with user access;
a centralized database storing a copy of the primary data;
a receiver associated with at least one of the plurality of computers receiving a second search inquiry;
the processor adapted to access at least one of the primary data or the copy of the primary data;
the processor adapted to create a search engine results page responsive to the second search inquiry, the search engine results page including a plurality of search engine results ranked based at least in part on an evaluation of at least one of the primary data or the copy of the primary data; and
a computer monitor associated with at least one of the computers displaying the search engine results page.

17. The system of claim 16, wherein the primary data includes at least one of an amount of time the user accessed one of the primary links, a number of times the user accessed one of the primary links, a number of web pages associated with one of the primary links that is accessed by the user, or a number of web pages accessed by the user via one of the primary links.

18. The system of claim 16, wherein the processor identifies the copy of the primary data as being associated with the user.

19. The system of claim 16, wherein the processor ranks the search engine results based at least in part on an evaluation of the primary data.

20. The system of claim 16, wherein the processor ranks the search engine results based at least in part on an evaluation of the copy of the primary data.

21. The system of claim 16, comprising:
the centralized database storing a copy of general data associated with access by a plurality of users to at least one of the primary links; and
the processor ranking the search engine results based at least in part on the copy of general data associated with access by the plurality of users.

22. The system of claim 16, wherein the receiver receives the second search inquiry from the user.

23. The system of claim 16, wherein the receiver receives the second search inquiry from a second user.

24. The system of claim 16, wherein the first search inquiry comprises at least one first keyword and wherein the second search inquiry comprises at least one second keyword that is different from the first keyword.

25. The system of claim 16, wherein the primary data includes at least one of an amount of time the user accessed one of the primary links, a number of times the user accessed one of the primary links, a number of web pages associated with one of the primary links that is accessed by the user, or a number of web pages accessed by the user via one of the primary links.

26. The system of claim 16 wherein the centralized database is accessed by any of the plurality of computers associated with the network.

27. The system of claim 16, comprising:
the processor monitoring activity of the user to determine user access to at least one of a plurality of secondary links, each secondary link accessed by the user via at least one of the primary links;
the local database storing a plurality of secondary data associated with user access to at least one of the secondary links;
the centralized database storing a copy of the secondary data;
the processor accessing at least one of the secondary data or the copy of the secondary data; and
the processor adapted to create the search engine results page with the plurality of search engine results ranked based at least in part on an evaluation of at least one of the secondary data or the copy of the secondary data.

28. The system of claim 27, wherein the processor identifies the copy of the secondary data as being associated with the user.

29. The system of claim 27, wherein the processor ranks the search engine results based at least in part on an evaluation of the secondary data.

30. The system of claim 27, wherein the processor ranks the search engine results based at least in part on an evaluation of the copy of the secondary data.

31. The system of claim 27 wherein the search engine results page comprises at least one primary link or at least one secondary link.

32. An article of manufacture comprising a program storage medium having computer readable program code embodied therein for ranking search results by at least one computer associated with a computer network, the computer readable program code in the article of manufacture comprising:
computer readable code for causing at least one computer to monitor activity of a user associated with the network to determine user access to at least one of a plurality of primary links associated with a response to a first search inquiry;
computer readable code for causing at least one computer to store in a local database a plurality of primary data associated with user access to at least one of the primary links;
computer readable code for causing at least one computer to store in a centralized database a copy of the primary data;
computer readable code for causing at least one computer to receive a second search inquiry;
computer readable code for causing at least one computer to access at least one of the primary data or the copy of the primary data;
computer readable code for causing at least one computer to create a search engine results page responsive to the second search inquiry, the search engine results page including a plurality of search engine results ranked based at least in part on an evaluation of at least one of the primary data or the copy of the primary data; and
computer readable code for causing at least one computer to display the search engine results page.

33. The article of manufacture of claim 32, comprising:
computer readable code for causing at least one computer to monitor the user to determine user access to at least one of a plurality of secondary links, each secondary link accessed by the user via at least one of the primary links;
computer readable code for causing at least one computer to store in a local database a plurality of secondary data associated with user access to at least one of the secondary links;
computer readable code for causing at least one computer to store in a centralized database a copy of the secondary data;
computer readable code for causing at least one computer to access at least one of the secondary data or the copy of the secondary data; and
computer readable code for causing at least one computer to create the search engine results page with the plurality of search engine results ranked based at least in part on an evaluation of at least one of the secondary data or the copy of the secondary data.

34. A system for ranking search engine results, comprising:
means for monitoring, by a processor associated with a network, activity of a user associated with the network to determine user access by the user to at least one of a plurality of primary links associated with a response to a first search inquiry;
means for storing in a local database associated with the user a plurality of primary data associated with user access to at least one of the primary links;
means for storing in a centralized database a copy of the primary data;
means for receiving a second search inquiry;
means for accessing at least one of the primary data or the copy of the primary data;
means for creating a search engine results page responsive to the second search inquiry, the search engine results page including a plurality of search engine results ranked based at least in part on an evaluation of at least one of the primary data or the copy of the primary data; and
means for displaying the search engine results page on a computer monitor associated with the processor.

35. The system of claim 34, comprising:
means for monitoring the user to determine user access to at least one of a plurality of secondary links, each secondary link accessed by the user via at least one of the primary links;
means for storing in a local database a plurality of secondary data associated with user access to at least one of the secondary links;
means for storing in a centralized database a copy of the secondary data;
means for accessing at least one of the secondary data or the copy of the secondary data; and
means for creating the search engine results page with the plurality of search engine results ranked based at least in part on an evaluation of at least one of the secondary data or the copy of the secondary data.
